(19) United States
(12) Patent Application Publication
(10) Pub. No.: US 2016/0259207 A1
(43) Pub. Date: Sep. 8, 2016

(54) ELECTRONIC APPARATUS

(71) Applicants: KABUSHIKI KAISHA TOSHIBA, Tokyo (JP); Toshiba Lifestyle Products & Services Corporation, Tokyo (JP)

(72) Inventor: Shinji Matsuo, Ome Tokyo (JP)

(73) Assignees: KABUSHIKI KAISHA TOSHIBA, Tokyo (JP); Toshiba Lifestyle Products & Services Corporation, Tokyo (JP)

(21) Appl. No.: 14/958,687

(22) Filed: Dec. 3, 2015

(30) Foreign Application Priority Data
Mar. 3, 2015 (JP) 2015-041403

(51) Int. Cl. G02F 1/1335; F21V 29/70

(52) U.S. Cl. CPC G02F 1/133603; F21V 29/70; G02F 1/133608; F21Y 2103/003

(57) ABSTRACT

According to one embodiment, an electronic apparatus includes a light reflection member including a light-reflecting surface on at least one surface, and including a first through-hole penetrating from the one surface to another surface, a luminous body provided on the one surface of the light reflection member, and including a light-emitting element, and a support member provided on a side of the other surface of the light reflection member, and including a second through-hole penetrating a surface facing the light reflection member and a surface opposite to the surface. Further, the first and second through-holes are provided to correspond to a position at which the light-emitting element is provided.

### CROSS-REFERENCE TO RELATED APPLICATIONS

This application is based upon and claims the benefit of priority from Japanese Patent Application No. 2015-041403, filed Mar. 3, 2015, the entire contents of which are incorporated herein by reference.

### FIELD

Embodiments described herein relate generally to an electronic apparatus considering externally directed thermal radiation.

### BACKGROUND

Liquid crystal televisions as electronic apparatuses are provided with a backlight including a luminous body such as an LED behind a liquid crystal panel. Various substrates such as a power substrate are attached within a housing.

The liquid crystal televisions must externally radiate heat produced by a backlight, a substrate, or the like to suppress internal temperature rise.

An electronic apparatus according to a first embodiment comprises a light reflection member including a light-reflecting surface on at least one surface, and comprising a first through-hole penetrating from the one surface to another surface, a luminous body provided on the one surface of the light reflection member, and including a light-emitting element, and a support member provided on a side of the other surface of the light reflection member, and including a second through-hole penetrating a surface facing the light reflection member and a surface opposite to the surface. Further, the first and second through-holes are provided to correspond to a position at which the light-emitting element is provided.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an elevation view of a liquid crystal television according to one embodiment.

FIG. 2 is a side view of the liquid crystal television.

FIG. 3 is a perspective view of the liquid crystal television from behind.

FIG. 4 is a disassembled perspective view with a television body disassembled.

FIG. 5 is a disassembled perspective view from behind with a unit cover detached from the liquid crystal television.

FIG. 6 is a perspective view of a back bezel of the liquid crystal television from the oblique rear side.

FIG. 7 is a partial sectional view of an attachment structure of an LED bar with the liquid crystal television cut by a longitudinal section.

FIG. 8 is a perspective view of the back bezel of the liquid crystal television from the front side.

FIG. 9 is a disassembled sectional view of the liquid crystal television cut by a plane taken along line F9-F9 in FIG. 8.

FIG. 10 is a sectional view of a power cord lead-out aperture of the liquid crystal television with the aperture cut.

FIG. 11 is a disassembled sectional view of the liquid crystal television cut by a plane taken along line F11-F11 in FIG. 8.

FIG. 12 is a perspective view of an inclined portion of the liquid crystal television from the oblique front side.

FIG. 13 is a perspective view of an inclined portion of the liquid crystal television from the oblique front side.

FIG. 14 is a partial sectional view of an attachment structure of an LED bar with a liquid crystal television according to a second embodiment cut by a longitudinal section.

FIG. 15 is a partial sectional view of an attachment structure of an LED bar with a liquid crystal television according to a third embodiment cut by a longitudinal section.

FIG. 16 is a partial sectional view of an attachment structure of an LED bar with a liquid crystal television according to a fourth embodiment cut by a longitudinal section.

FIG. 17 is a perspective view of a back bezel of a liquid crystal television according to a fifth embodiment from the oblique rear side.

FIG. 18 is a perspective view of a unit cover of a liquid crystal television according to a sixth embodiment from the oblique rear side.

### DETAILED DESCRIPTION

Various embodiments will be described hereinafter with reference to the accompanying drawings.

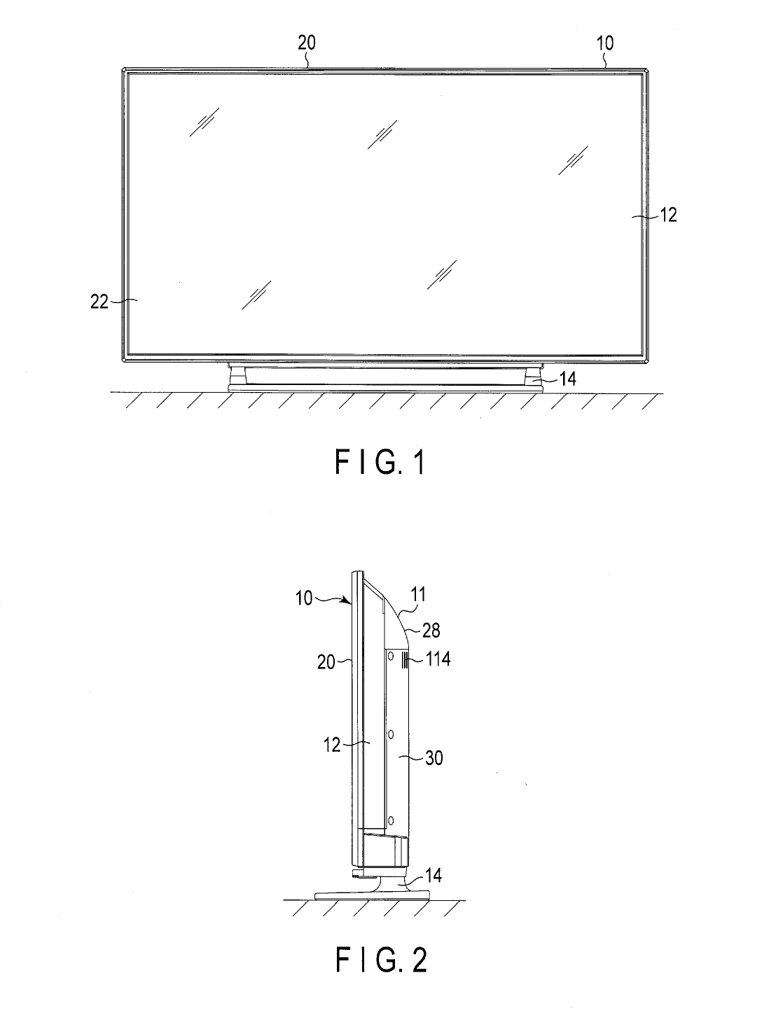

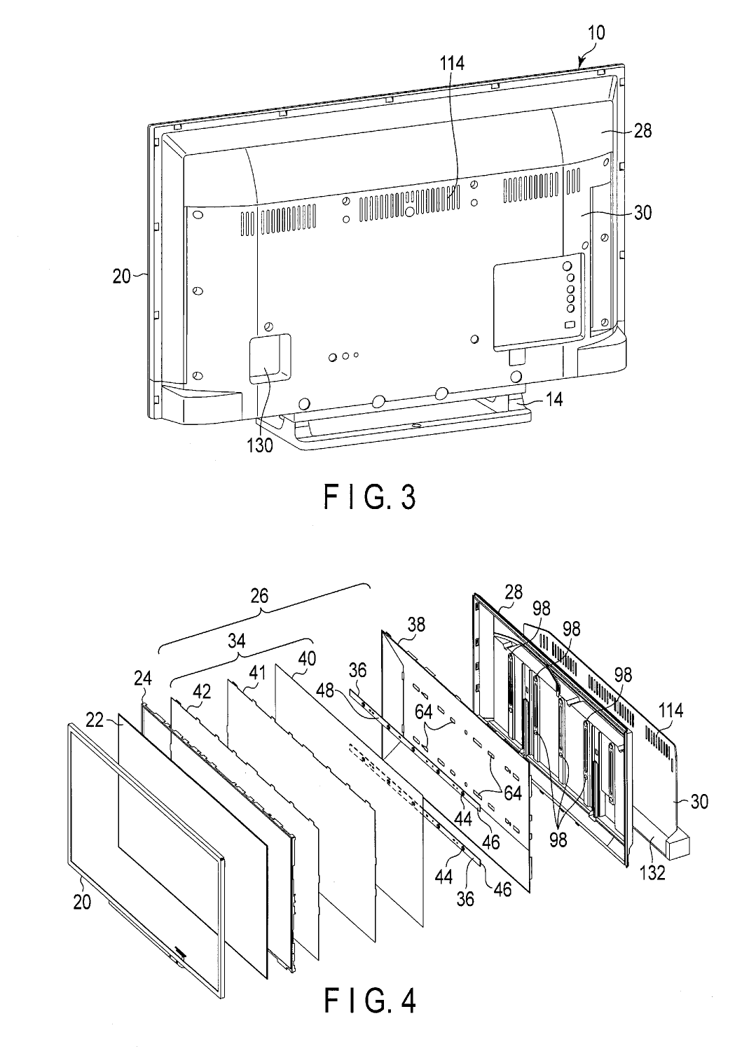

A liquid crystal television 10 according to the first embodiment will be described with reference to the drawings. FIG. 1 is an elevation view of the front surface of the liquid crystal television 10 which is an example of an electronic apparatus. FIG. 2 is a side view of the liquid crystal television 10 from the right side surface. FIG. 3 is a perspective view of the back surface of the liquid crystal television 10 from the oblique upper side. FIG. 4 is a disassembled perspective view with a television body 12 disassembled.

The liquid crystal television 10 comprises the television body 12 and a table stand 14 located under the television body 12 and supporting the television body 12. The liquid crystal television 10 is installed on television table T, etc., by the table stand 14 attached to the lower portion of the television body 12.

Basically, in the following description of the liquid crystal television 10, the video display surface side of the liquid crystal television 10 is defined as the front, and the side opposite thereto is defined as the back in a state where the television body 12 stands vertically (that is, in a state where the video display surface of a liquid crystal panel 22 to be described is set vertically), and then, the right and left of the liquid crystal television 10 are defined. Further, the direction of gravitational force is defined as downward relative to the liquid crystal television 10, and the direction opposite thereto is defined as upward in the state. The liquid crystal television 10 is placed vertically for convenience of description.

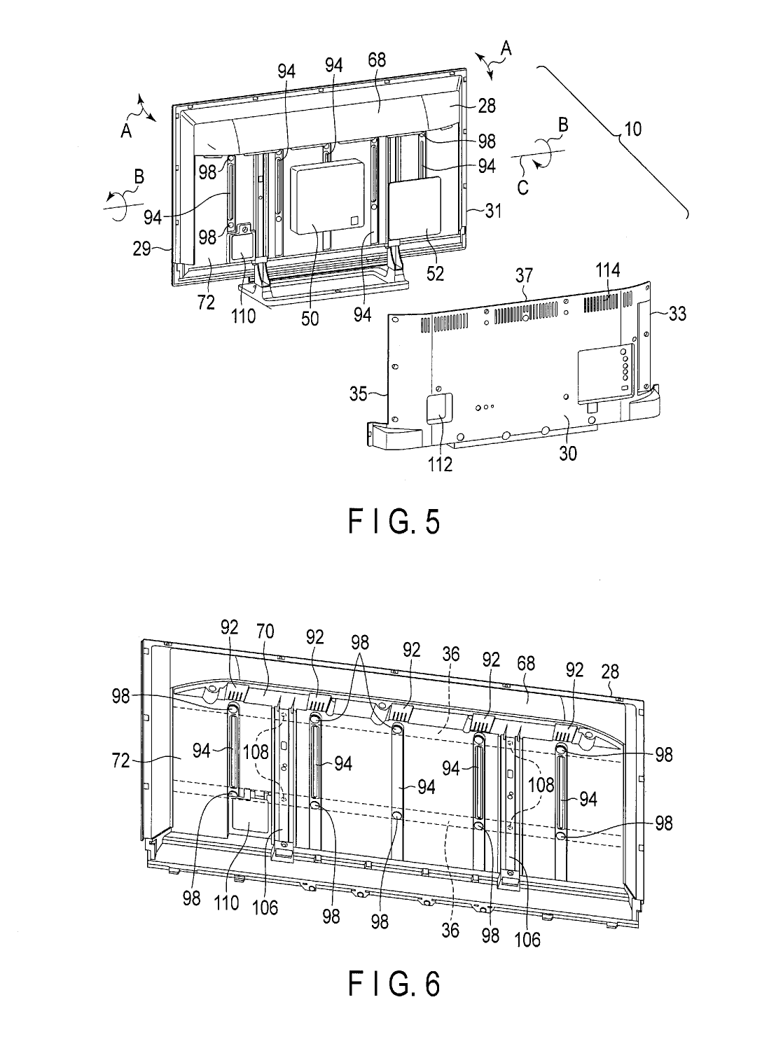

The television body 12 comprises a front bezel 20, the liquid crystal panel 22 as a video display cell, a frame 24, a backlight 26, a back bezel 28 as a support member, and a unit cover 30, as shown in FIG. 4. Further, a power supply substrate 50 and a control substrate 52 are attached on the back surface of the back bezel 28, as shown in FIG. 5.

The front bezel 20 is a rectangular frame member, as shown in FIG. 4, and attached to the front edge of the back bezel 28. The front bezel 20, the back bezel 28 and the unit cover 30 form a housing 11 of the liquid crystal television 10. The housing 11 is rectangular, and expanded at the back, as shown in FIGS. 2 and 3.

The liquid crystal panel 22 is a light-irradiated body, and is constituted by overlaying at least a liquid crystal unit 31 and a polarizing film 32. It switches between a state where light radiated by the backlight 26 is transmitted and a state where the light is blocked to form an image. The video display panel is not limited to the liquid crystal panel 22.

The frame 24 is a member formed in a rectangular frame shape, and arranged behind the liquid crystal panel 22 to hold the liquid crystal panel 22 after the liquid crystal panel 22 is attached to the front bezel 20. The backlight 26 is provided behind the liquid crystal panel 22.

The backlight 26 includes an optical member 34, an LED bar 36 as a luminous body (which is also a heat producer), and a reflection sheet 38 as a light reflection member. The optical member 34 is constituted by properly including various optical sheets such as a diffusion panel 40, a prism sheet 41, and a diffusion sheet 42. It diffuses light of the LED bar 36, and supplies homogeneous light without a luminance spot to the liquid crystal panel 22.

The LED bar 36 includes an elongated mounting substrate 46 and a light-emitting diode (LED) 44 as a light-emitting element arranged on a first surface (front surface) 48 of the mounting substrate 46.

The mounting substrate 46 is formed of a member having excellent heat conductivity such as aluminum or aluminum alloy. The material of the mounting substrate 46 is not limited to aluminum, etc., if it has excellent heat conductivity. Interconnect for supplying power for emitting the LED 44 to the LED 44 is printed on the mounting substrate 46.

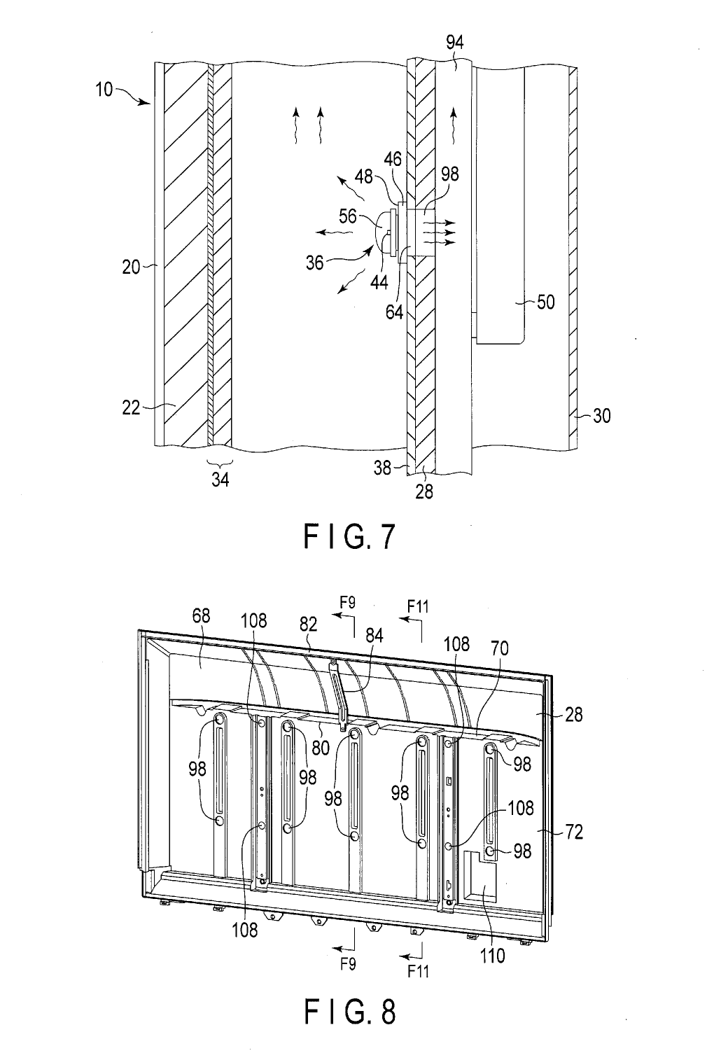

The LED 44 is attached at five places on the first surface 48 of the mounting substrate 46 at predetermined intervals. A lens portion 56 covering the LED 44 is provided on the front surface of the LED 44, as shown in FIG. 7. Light passing through the lens portion 56 is widely diffused on the side of the first surface 48. The LED 44 including the lens portion 56 is sometimes called the LED 44 in the present embodiment. Two LED bars 36 are provided in parallel on the reflection sheet 38 at a predetermined interval in the up and down direction.

The reflection sheet 38 is formed of, for example, a foam synthetic resin material, and has high optical reflectivity. The reflection sheet 38 comprises a reflection surface at least on a surface on the side of the liquid crystal panel 22, that is, on the side of the front surface. The LED bar 36 is provided in piles on the reflection surface (front surface) of the reflection sheet 38.

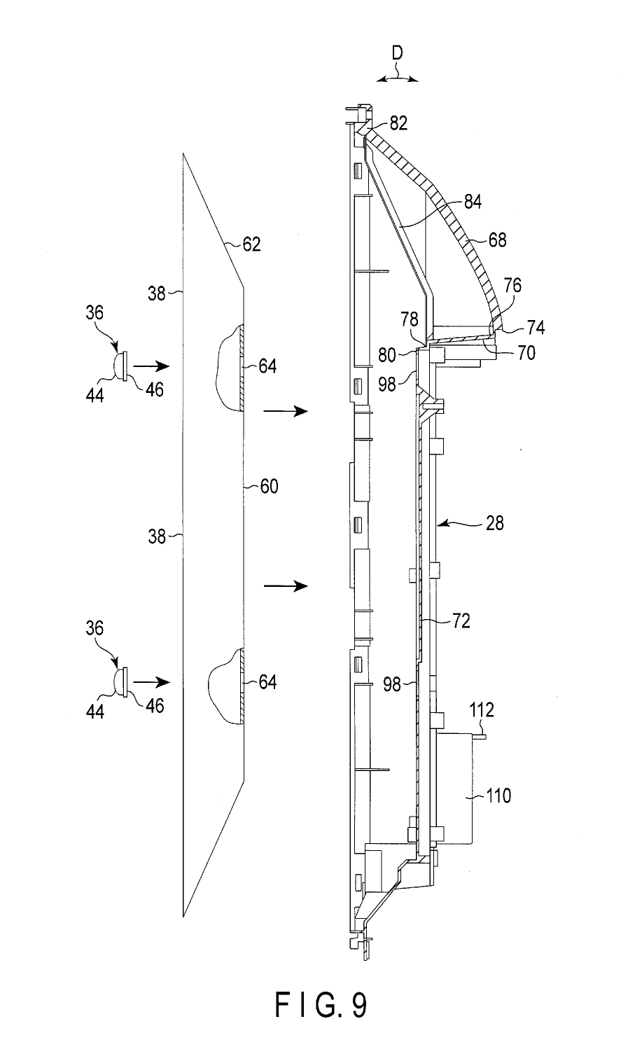

The reflection sheet 38 comprises a plane portion 60, which is basically rectangular and formed to be flat, on the central portion, as shown in FIGS. 4 and 9, and comprises an inclined portion 62 inclined frontward at a predetermined angle around the plane portion 60.

A through-hole 64 as a first through-hole is provided in the plane portion 60 at a position where the LED 44 is arranged, when the LED bar 36 is attached. The through-hole 64 penetrates the front and back of the reflection sheet 38, and is in a substantially ellipse shape formed to be long in a direction along the longitudinal direction of the LED bar 36, as shown in FIG. 4. The through-hole 64 is formed at least at a position where the LED 44 is attached.

The through-hole 64 may be formed to be a hole large in the lateral direction across a plurality of adjacent LEDs 44 unless it constitutes an obstacle in terms of strength. Further, the through-hole 64 is preferably formed to be within the longitudinal width of the mounting substrate 46 of the LED bar 36 in the lengthwise direction, and not to partially protrude from the upper and lower sides of the mounting substrate 46 of the LED bar 36 when the LED bar 36 is attached on the upper surface of the reflection sheet 38. A hole through which an attachment screw of the LED bar 36 passes is also provided on the reflection sheet 38. The reflection sheet 38 need not be made of a foam synthetic resin material if it is made of a material with high optical reflectivity. The back bezel 28 is provided on the rear surface of the reflection sheet 38.

FIG. 9 shows a section of the back bezel 28. FIG. 9 is a sectional view of a state where the back bezel 28 is cut by a plane taken along line F9-F9 in FIG. 8. The whole of the back bezel 28 is attached to the front bezel 20 and in a rectangular shape.

As shown in FIG. 9, the back bezel 28 is roughly divided into three portions of an upper curved portion 68 as an upper plate curved from the above to the back, a lateral plate 70 provided in the front and back direction, and a flat plate 72 provided in the lengthwise direction. The three portions of the upper curved portion 68, the lateral plate 70, and the flat plate 72 are preferably integrally formed of a synthetic resin material.

The upper curved portion 68 is convexly curved from an upper end 82 to the back, as shown in the longitudinal section of FIG. 9. The lower end 74 of the upper curved portion 68 is formed substantially horizontally, and a lower end 74 is connected to a tip portion 76 of the lateral plate 70.

The lateral plate 70 is substantially flat, and the tip portion 76 is in a shape along the curve of the lower end 74 of the upper curved portion 68. A base end 78 of the lateral plate 70 is substantially straight, and the base end 78 is connected to the upper end 80 of the flat plate 72. The lateral plate 70 need not be attached to the upper end of the flat plate 72 if it is attached to the portion above the center in the up and down direction of the flat plate 72.

The flat plate 72 is formed to be flat. The flat plate 72 is provided basically parallel to the liquid crystal panel 22. If the liquid crystal television 10 is vertically placed, the flat plate 72 is formed to be also vertically arranged.

The back bezel 28 with such a shape has adequate strength to force A of moving left and right end edges 29 and 31 of the back bezel 28 in the front and back direction relative to the central portion of the back bezel 28, and force B of twisting the left and right end edges 29 and 31 of the back bezel 28 around central axis C, as shown in FIG. 5.

Further, as shown in FIGS. 8 and 9, a reinforcing member 84 is provided between the upper curved portion 68 and the flat plate 72 of the back bezel 28. The reinforcing member 84 is a metallic plate member, includes a screw hole in each of the upper and lower potions, and is screwed substantially at the center in the right and left direction of the back bezel 28. The upper portion of the reinforcing member 84 is fixed to the upper end 82 of the upper curved portion 68, and the lower portion is fixed to the upper end 80 of the flat plate 72, as shown in FIG. 9.

Since the reinforcing member 84 is attached between the upper end 82 of the upper curved portion 68 and the upper end 80 of the flat plate 72, a triangle reinforcing structure, which is surrounded by the upper curved portion 68, the lateral plate 70, and the reinforcing member 84, is formed above the back bezel 28, as shown in FIG. 9. Thus, the back bezel 28 has adequate strength to force D of moving the upper end 82 of the upper curved portion 68 in the front and back direction relative to the flat plate 72.

The reinforcing member 84 need not be made of metal if it has desired strength. It may be made of a synthetic resin. The reinforcing member 84 is not necessarily attached at one position. It may be properly attached at predetermined positions of the back bezel 28. The upper portion of the reinforcing member 84 is preferably fixed to the upper curved portion 68 along with a metallic bracket provided around the back bezel 28.

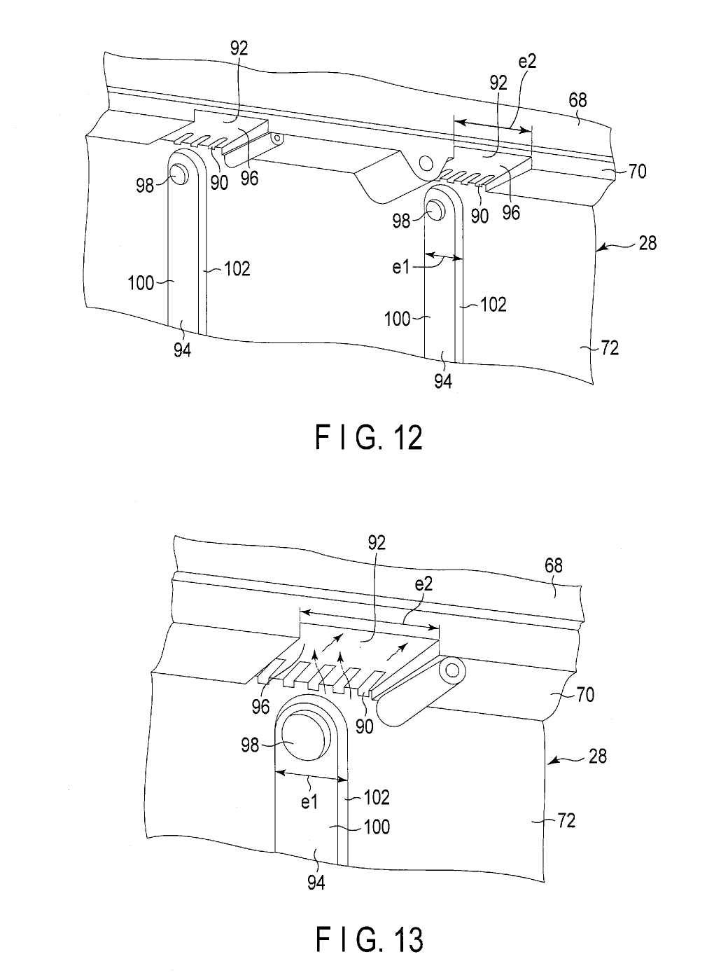

An inclined portion 92 including a slit 90 as a first slit is formed on the lateral plate 70, as shown in FIG. 6. The inclined portion 92 includes a flat ceiling wall 96, and is positioned to correspond to at least a groove portion 94 to be described, as shown in FIGS. 12 and 13.

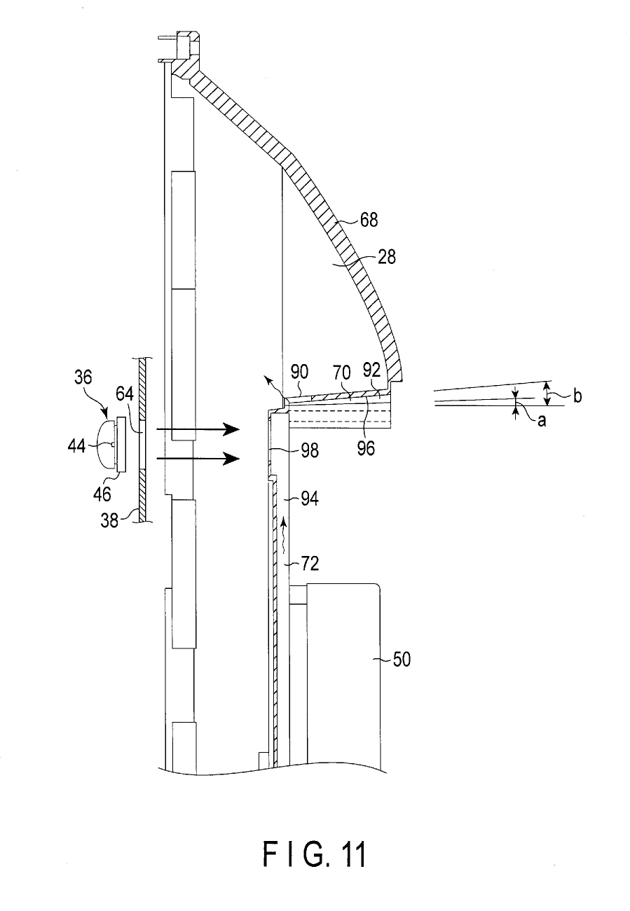

FIG. 11 is a sectional view of the periphery of the upper curved portion 68 cut by a plane taken along line F11-F11 in FIG. 8. The reinforcing member 84 is omitted in FIG. 11.

As shown in FIG. 11, the lateral plate 70 is connected to the flat plate 72 such that angle a defined by the lateral plate 70 and the perpendicular line of the flat plate 72 is approximately +3 degrees. On the other hand, the ceiling wall 96 of the inclined portion 92 is formed such that angle b defined by the ceiling wall 96 and the perpendicular line of the flat plate 72 is slightly greater than the angle defined by the lateral plate 70 and the flat plate 72, that is, angle b is approximately +10 degrees.

The inclined portion 92 has width e2 greater than width e1 of the groove portion 94. A plurality of slits 90 are provided inside the inclined portion 92. Each of the slits 90 penetrates the front and back of the back bezel 28, and communicates the rear surface side of the flat plate 72 with the inner portion of the upper curved portion 68.

Each of the slits 90 includes both of the ceiling wall 96 of the inclined portion 92 and the flat plate 72 crossing the ceiling wall 96, and is formed in a direction substantially along the front and back direction of the liquid crystal television 10. Width e2 in the right and left direction of the inclined portion 92 may be formed to be greater on the front side than on the back side.

The groove portion 94 and a through-hole 98 as a second through-hole are provided on the flat plate 72, as shown in FIG. 6. The groove portion 94 includes a bottom portion 100 and a longitudinal wall 102 provided on both of right and left sides of the bottom portion 100, and is formed to be depressed on the side of the liquid crystal panel 22, as shown in FIGS. 12 and 13. The groove portion 94 is vertically formed at five places at intervals identical to those of the LED 44 provided in the LED bar 36. The groove portions 94 need not be completely vertically provided. Each of the groove portions 94 basically extends from the upper end to the lower end of the flat plate 72. The inclined portion 92 is provided in the upper portion of each of the groove portions 94, as described above. Some groove portion 94 overlaps the power supply substrate 50 and the control substrate 52 attached to the flat plate 72, is covered on one side of the groove portion 94, and cylindrically formed. The through-hole 98 is provided in the bottom portion 100 of the groove portion 94.

The through-hole 98 is circular, penetrates the front and back of the flat plate 72, and is provided at five places in parallel in each of upper and lower stages to correspond to a position where the LED 44 is arranged when the LED bar 36 is attached.

Further, a connecting fitting 106 connected to an attachment leg of the table stand 14 is attached on the flat plate 72, as shown in FIG. 6. The connecting fitting 106 is a long and thin metallic fitting, and provided at two bilaterally symmetrical places on the back bezel 28. The connecting fitting 106 extends from the lower portion of the back bezel 28 to the upper portion of the flat plate 72, and is connected to the leg of the table stand 14 if the table stand 14 is fixed to the television body 12. Further, a through-hole 108 penetrating the front and back of the flat plate 72 is provided on the flat plate 72 in a position where the connecting fitting 106 crosses the LED bar 36 in the front and back direction.

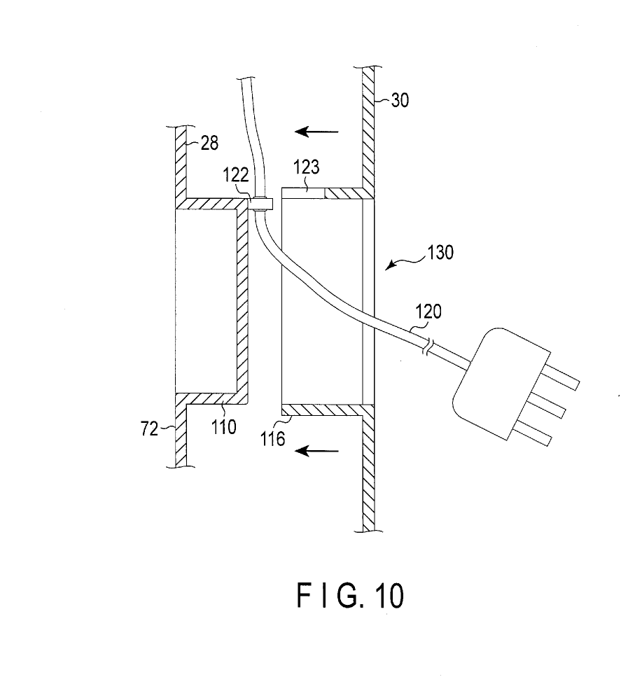

Further, a pedestal portion 110 forming a power cord lead-out aperture 130 as an interconnect lead-out aperture is provided on the flat plate 72 of the back bezel 28, as shown in FIGS. 6 and 10. The pedestal portion 110 is rectangular and projected at the back to a predetermined extent, as shown also in FIG. 6. The back surface of the pedestal portion 110 is formed to be flat. An engaging portion 122 with which a power cord 120 is engaged as a lead-out portion of interconnect is provided in the pedestal portion 110. A frame body portion 112 provided in the unit cover 30 to be described is fitted to the pedestal portion 110.

Since the pedestal portion 110 is provided on the back bezel 28 in this manner, the back bezel 28 has an effect equivalent to the case where the thickness of the flat plate 72 substantially increases, and the strength to flexure and torsion is improved. The unit cover 30 is attached behind the back bezel 28.

The unit cover 30 is shaped such that an upper edge 37 continues to the lower end 74 of the upper curved portion 68 of the back bezel 28, and the unit cover 30 forms the back surface of the liquid crystal television 10 along with the back bezel 28.

A slit 114, as a second slit, penetrating the front and back of the unit cover 30 is formed in the upper portion of the unit cover 30. The slit 114 is formed at least at positions corresponding to the inclined portion 92, the upper portion of the power supply substrate 50, and the upper portion of the control substrate 52.

The frame body portion 112 is provided in the unit cover 30 to correspond to the pedestal portion 110, as described above. The frame body portion 112 includes wall portions 116 fitted around the pedestal portion 110 on all four sides. A notch portion 123 avoiding the engaging portion 122 with which the power cord 120 is engaged is provided in the frame body portion 112.

The inner portion of the frame body portion 112 surrounded by the wall portions 116 includes space. When the unit cover 30 is attached to the back bezel 28, and the frame body portion 112 is attached to the pedestal portion 110, the power cord lead-out aperture 130 is formed on the back surface of the liquid crystal television 10. The power cord lead-out aperture 130 is surrounded by the wall portions 116, and the outside of the liquid crystal television 10 is disconnected from the inner space of the unit cover 30 unless the power cord 120 of the liquid crystal television 10 is led out.

As shown above, the frame body portion 112 is formed in the unit cover 30 by the wall portions 116 extending in the front and back direction. The wall portions 116 are arranged at four places to be rectangular, and the corners of the wall portions 116 are connected to each other. Thus, the unit cover 30 has an effect equivalent to the case where the thickness substantially increases, and the strength to deformation is improved.

Both of the right and left sides of the unit cover 30 are curved forward, and left and right end edges 33 and 35 are connected to the left and right end edges 29 and 31 of the flat plate 72 of the back bezel 28, as shown in FIG. 4. A flat bottom plate 132 extending forward is provided in the lower end of the unit cover 30, and is connected to the lower end portion of the flat plate 72. A slit penetrating the front and back of the unit cover 30 including the bottom plate 132 is formed around the lower end portions of the unit cover 30. The slit provided around the lower end portion of the unit cover 30 mainly functions as an external air inlet for bringing external air into the liquid crystal television 10.

Next, an operation and an advantage of the liquid crystal television 10 according to the first embodiment will be described. When the LED 44 of the backlight 26 is turned on, light produced by the LED 44 is not only directly irradiated forward, but also reflected by the reflection sheet 38 and irradiated forward. The light irradiated forward passes through the optical member 34 such as the diffusion panel 40, and is uniformly diffused. The liquid crystal panel 22 is irradiated with the light from the back.

Heat produced by the LED 44 because of the lighting of the LED 44 is emitted in front of the LED 44 through the lens portion 56, as shown in FIG. 7. The heat emitted in front of the LED 44 heats air in front of the LED 44. The heated air rises in a space formed between the reflection sheet 38 and the optical member 34, and produces a convection current inside the liquid crystal television 10. This allows the heat produced by the LED 44 to be radiated in front of the LED 44 to suppress the temperature rise of the LED 44.

Further, the heat produced by the LED 44 is transmitted to the mounting substrate 46 which is behind the LED 44, and heats the mounting substrate 46. The heat of the heated mounting substrate 46 is radiated behind the back bezel 28 through the through-hole 64 of the reflection sheet 38 and the through-hole 98 provided on the flat plate 72 of the back bezel 28. This can suppress the temperature rise of the LED 44.

In addition, the heat radiated from the through-hole 98 provided on the back bezel 28 warms air around the through-hole 98. The warmed air around the through-hole 98 rises to the lateral plate 70 through the inner portion of the groove portion 94. Part of the warm air that has reached the lateral plate 70 flows in the space partitioned by the upper curved portion 68 and the reflection sheet 38 through the slit 90, as shown in FIGS. 11 and 13.

Further, part of the warm air that has reached the lateral plate 70 flows to the back of the back bezel 28 along the inclination of the inclined portion 92, and is emitted from the slit 114 formed on the unit cover 30 out of the liquid crystal television 10. The inclined portion 92 is inclined more than the lateral plate 70, and can effectively externally radiate the warm air.

When the warm air rises in the groove portion 94, external air is drawn into a space between the unit cover 30 and the back bezel 28, part of the external air rises in the groove portion 94, and the temperature around the through-hole 98 decreases.

As described above, in the liquid crystal television 10 according to the first embodiment, the heat produced by the LED 44 of the backlight 26 passes through the reflection sheet 38 and the back bezel 28 and is radiated through the through-hole 64 and the through-hole 98 provided behind a position where the LED 44 is attached.

This allows the heat produced by the LED 44 to be radiated behind the back bezel 28 to suppress the temperature rise of the LED 44. Furthermore, since the warm air passing along the groove portion 94 smoothly rises, and is effectively emitted out of the liquid crystal television 10 through the inclined portion 92, the temperature rise can be effectively suppressed.

Further, the heat emitted from the power supply substrate 50 or the control substrate 52 attached on the flat plate 72 of the back bezel 28 warms air around the power supply substrate 50, etc. The air warmed on the power supply substrate 50, etc., rises in a space partitioned by the flat plate 72 of the back bezel 28 and the unit cover 30.

The warm air that has risen in the space between the flat plate 72 and the unit cover 30 reaches the lateral plate 70, and flows to the back along the inclination of the lateral plate 70. Since the inclination of the lateral plate 70 is designed such that the back side of the back bezel 28 is higher than the front side, the warm air is smoothly conveyed to the back. Since the slit 114 penetrating the front and back of the unit cover 30 is formed in the upper portion of the unit cover 30, the warm air led to the back of the back bezel 28 along the lateral plate 70 is discharged from the liquid crystal television 10 through the slit 114.

At the same time, since external air is drawn from the slit provided in the lower portion of the unit cover 30 into the space between the unit cover 30 and the flat plate 72 of the back bezel 28, the power supply substrate 50, etc., is cooled by the external air. The slit 114 need not be provided in the lengthwise direction. It may be provided in the lateral direction. The slit 114 need not be long or thin. It may be in any shape, for example, circular or rectangular.

Furthermore, since the through-hole 108 is provided at a crossing position of the LED bar 36 and the connecting fitting 106, heat from the LED bar 36 is emitted to the connecting fitting 106 through the through-hole 108. The connecting fitting 106 is a comparatively large metallic member extending in the lengthwise direction, and has large heat capacity, the lower portion of which is connected to the table stand 14, that is, connected to the outside. Thus, the heat of the LED bar 36 can be effectively absorbed, and radiated out of the liquid crystal television 10. Accordingly, the liquid crystal television 10 can effectively externally discharge the heat produced by the LED 44 to suppress temperature rise.

Further, since the through-hole 64 of the reflection sheet 38 is formed in an ellipse shape, and has a large opening area, an area in which the LED bar 36 is in contact with the reflection sheet 38 having high heat insulating properties is reduced, allowing the heat of the LED bar 36 to be effectively radiated to the rear surface side of the back bezel 28 to suppress the temperature rise of the LED bar 36.

Next, the liquid crystal television 10 according to second to sixth embodiments will be described. In each embodiment, the same structural elements as those in the liquid crystal television 10 according to the first embodiment are denoted by the same reference numbers. The description of the structural elements denoted by the same reference numbers are replaced with that in the first embodiment. Since the overall structure of the liquid crystal television 10 according to each embodiment is similar to that of the liquid crystal television 10 according to the first embodiment, the description in the first embodiment is taken into consideration.

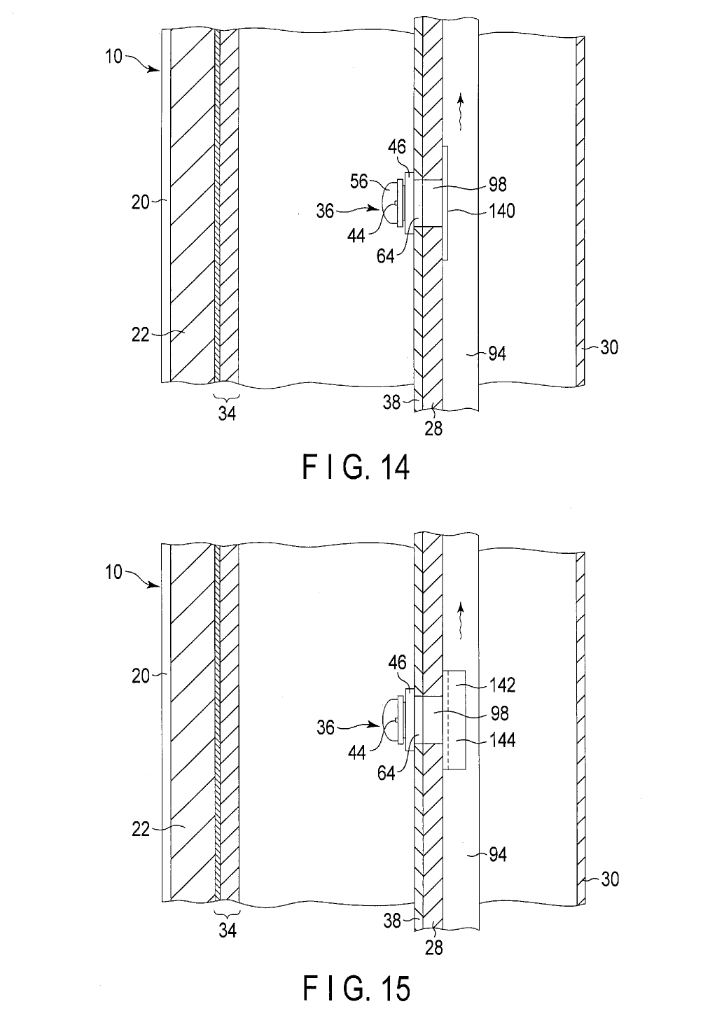

The liquid crystal television 10 according to the second embodiment will be described with reference to FIG. 14. In this embodiment, a metallic plate 140 is attached to the back bezel 28 to correspond to the through-hole 98 provided to radiate the heat from the LED 44. The metallic plate 140 is a metallic plate with high heat conductivity, absorbs the heat radiated from the mounting substrate 46 of the LED bar 36, and is heated. Then, the heat is emitted from the metallic plate 140 to its periphery, or air around the metallic plate 140 is heated to radiate the heat to the back of the back bezel 28. Accordingly, the heat of the mounting substrate 46 on the LED bar 36 can be effectively radiated to suppress the temperature rise of the LED 44.

The metallic plate 140 need not be attached to completely cover the through-hole 98. It may be attached apart from the flat plate 72 of the back bezel 28. Then, the LED bar 36 can be cooled also by the discharge of the warm air in the through-hole 98. Further, the metallic plate 140 may be attached on the flat plate 72 in such a manner that a hole is made on the metallic plate 140 or the through-hole 98 is partially opened by displacing the metallic plate 140 from the through-hole 98.

The liquid crystal television 10 according to the third embodiment will be described with reference to FIG. 15. In this embodiment, a heat sink 142 is attached to the through-hole 98 provided on the back bezel 28. A heat radiating fin 144 of the heat sink 142 as a heat radiation portion is exposed to the back of the back bezel 28, and the end on the heat absorption side directly contacts the mounting substrate 46 of the LED bar 36.

Thus, heat is transmitted from the mounting substrate 46 to the heat sink 142, and the heat transmitted to the heat sink 142 is radiated from the heat radiating fin 144 to the back of the back bezel 28. Accordingly, the heat of the LED 44 on the LED bar 36 can be effectively externally radiated to suppress temperature rise.

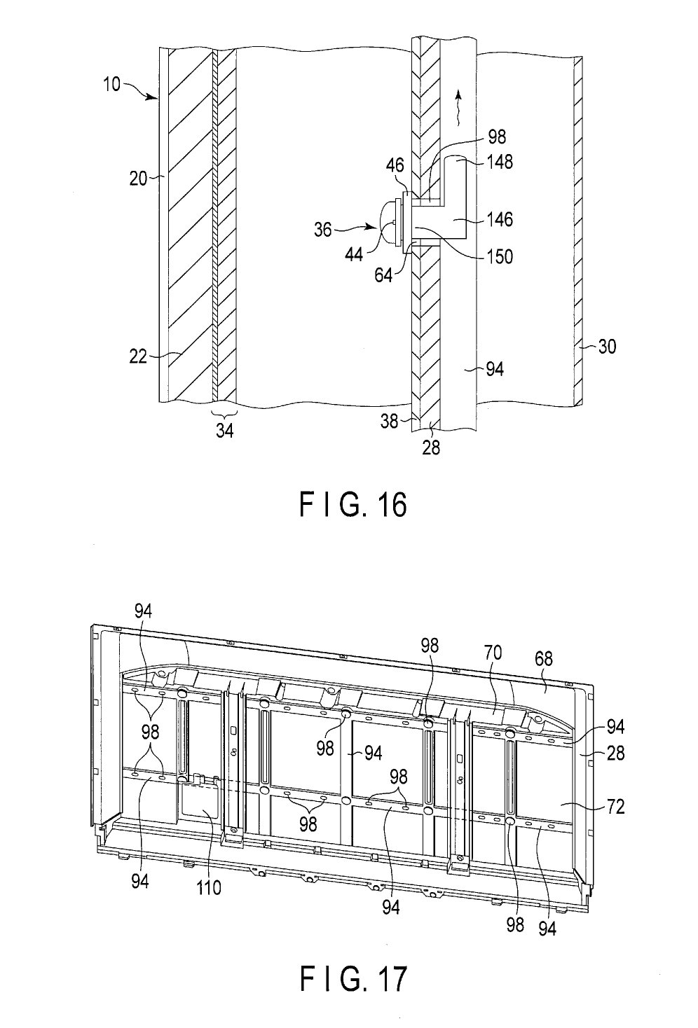

The liquid crystal television 10 according to the fourth embodiment will be described with reference to FIG. 16. In this embodiment, a heat pipe 146 is attached to the through-hole 98 provided on the back bezel 28. An end 148 on the heat radiation side of the heat pipe 146 as a heat radiation portion is preferably arranged in the upper portion of the groove portion 94 of the back bezel 28, and an end 150 on the heat absorption side of the heat pipe 146 preferably directly contacts the mounting substrate 46 of the LED bar 36. Further, in the embodiment, the through-hole 98 and the through-hole 64 may be formed to be a long hole which is long in one direction.

Thus, the heat of the mounting substrate 46 is transmitted to the end 150 of the heat pipe 146, and radiated from the end 148 on the heat radiation side to the groove portion 94 of the back bezel 28 through the heat pipe 146. Accordingly, the heat of the LED 44 on the LED bar 36 can be effectively radiated to suppress temperature rise.

The liquid crystal television 10 according to the fifth embodiment will be described with reference to FIG. 17. In this embodiment, the groove portion 94 is provided on the back bezel 28 also in the lateral direction. The groove portion 94 extending in the lateral direction is formed to correspond to the attachment position of the LED bar 36. Furthermore, a plurality of through-holes 98 penetrating the front and back of the back bezel 28 are provided in the groove portion 94 in the lateral direction. Such through-holes 98 preferably correspond to the through-holes 64 of the reflection sheet 38. Further, the through-holes 98 and the through-holes 64 may be formed to be long holes which are long in one direction.

Thus, the plurality of through-holes 98 are arranged on the rear surface side of the mounting substrate 46 on the LED bar 36, and connected to each other by the groove portion 94. Then, the heat of the mounting substrate 46 is emitted to the groove portion 94 through each of the through-holes 98. Since positions where the through-holes 98 are provided are not always on the back of the LED 44, the heat transmitted from the LED 44 to the mounting substrate 46 is radiated from each portion of the LED bar 36 to the back side of the back bezel 28.

Further, warm air produced in the groove portion 94 in the lateral direction moves to the groove portion 94 in the lengthwise direction through the groove portion 94, rises in the groove portion 94 in the lengthwise direction, and is emitted out of the liquid crystal television 10 through the slit 114. Thus, the liquid crystal television 10 according to this embodiment allows the heat of the LED 44 on the LED bar 36 to be effectively radiated to suppress temperature rise.

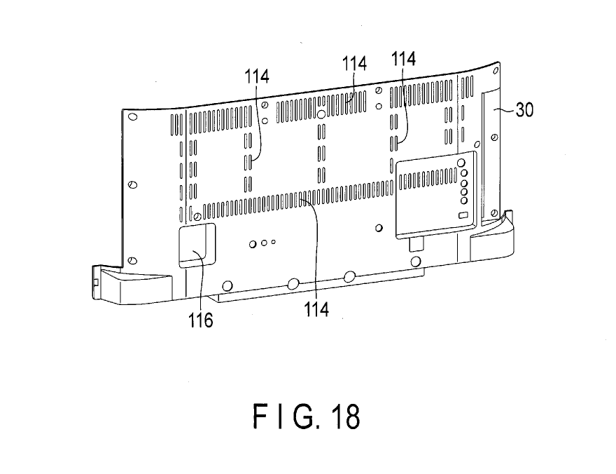

The liquid crystal television 10 according to the sixth embodiment will be described with reference to FIG. 18. In this embodiment, the slit 114 is formed on the unit cover 30 to correspond to the attachment position of the LED bar 36 and the position of the groove portion 94. The slit 114 is provided in five places in the lengthwise direction, and in a substantially central portion in the up and down direction of the unit cover 30 in the lateral direction.

Thus, the slit 114 is arranged on the rear surface side of the position at which the LED bar 36 is attached, and provided also in part of the groove portion 94. Then, the heat of the mounting substrate 46 is emitted out of the back bezel 28 through each of slits 114 provided in the lateral direction. In addition, the warm air in the groove portion 94 is directly externally radiated from each of the slits 114 of the liquid crystal television 10 except when the warm air is covered with the power supply substrate 50. Thus, the liquid crystal television 10 according to this embodiment allows the heat of the LED 44 on the LED bar 36 to be effectively radiated out of the liquid crystal television 10 through the slit 114 to suppress temperature rise. The slits 114 need not be provided in both of the lengthwise direction and the lateral direction. It may be provided in either of them.

The electronic apparatus is not limited to the liquid crystal television 10. The structure according to each embodiment can be applied to other electronic apparatuses in which a luminescent device is used. The backlight 26 is not limited to a backlight of the liquid crystal television 10. The structure in each embodiment can be applied to illuminating devices, etc., used independently for lighting if it includes the LED 44 and the reflection sheet 38. Further, a plurality of LED bars 36 and a plurality of LEDs 44 need not be used for the backlight 26. The structure of each embodiment can be applied to the backlight 26 in which at least one LED 44 is used. Further, the luminous body in each embodiment is not limited to an LED. Other light sources may be used.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus, comprising:
a light reflection member including a light-reflecting surface on at least one surface, and comprising a first through-hole penetrating from the one surface to another surface;
a luminous body provided on the one surface of the light reflection member, and including a light-emitting element; and
a support member provided on a side of the other surface of the light reflection member, and including a second through-hole penetrating a surface facing the light reflection member and a surface opposite to the surface,
wherein the first and second through-holes are provided to correspond to a position at which the light-emitting element is provided.

2. The electronic apparatus of claim 1, wherein a groove portion, at a bottom of which the second through-hole is arranged, is provided on a surface of the support member along a vertical direction, the surface being opposite to a surface on which the light reflection member is provided.

3. The electronic apparatus of claim 2, wherein
the luminous body includes a plurality of light-emitting elements linearly arranged on a mounting substrate, and
the first and second through-holes are formed to be long along an arrangement direction of the light-emitting element.

4. The electronic apparatus of claim 3, wherein
a plurality of luminous bodies are provided on upper and lower sides by arranging a longitudinal direction of the luminous body in a lateral direction of the support member, and
the groove portion is provided also in a right and left direction of the support member.

5. The electronic apparatus of claim 1, wherein a metallic plate is attached at a position corresponding to the light-emitting element of the support member.

6. The electronic apparatus of claim 2, wherein a metallic plate is attached at a position corresponding to the light-emitting element of the support member.

7. The electronic apparatus of claim 3, wherein a metallic plate is attached at a position corresponding to the light-emitting element of the support member.

8. The electronic apparatus of claim 1, wherein a heat sink is attached at a position corresponding to the light-emitting element of the support member.

9. The electronic apparatus of claim 2, wherein a heat sink is attached at a position corresponding to the light-emitting element of the support member.

10. The electronic apparatus of claim 3, wherein a heat sink is attached at a position corresponding to the light-emitting element of the support member.

11. The electronic apparatus of claim 1, wherein a heat pipe in which a heat radiation portion is arranged outside the first and second through-holes is attached at a position corresponding to the light-emitting element of the support member.

12. The electronic apparatus of claim 2, wherein a heat pipe in which a heat radiation portion is arranged outside the first and second through-holes is attached at a position corresponding to the light-emitting element of the support member.

13. The electronic apparatus of claim 3, wherein a heat pipe in which a heat radiation portion is arranged outside the first and second through-holes is attached at a position corresponding to the light-emitting element of the support member.

14. An electronic apparatus, comprising:
a light reflection member including a light-reflecting surface on at least one surface, and a first through-hole penetrating the one surface and another surface;
a luminous body provided on the one surface of the light reflection member, and comprising a light-emitting element;
a back bezel provided on a side of the other surface of the light reflection member, and including a second through-hole penetrating a surface facing the light reflection member and a surface opposite to the surface; and
a video display cell configured to control a passage of light irradiated from the luminous body by liquid crystal driving and to form an image,
wherein the first and second through-holes are provided to correspond to a position at which the light-emitting element is provided.

15. The electronic apparatus of claim 14, wherein a groove portion including the second through-hole at a bottom is provided on a surface of the back bezel along a vertical direction, the surface being opposite to a surface of the light reflection member.

16. The electronic apparatus of claim 15, wherein
the luminous body includes a plurality of light-emitting elements linearly arranged on a mounting substrate, and
the first and second through-holes are formed to be long along an arrangement direction of the light-emitting element.

17. The electronic apparatus of claim 16, wherein
a plurality of luminous bodies are provided on upper and lower sides by arranging a longitudinal direction of the luminous body in a lateral direction of the back bezel, and
the groove portion is provided also in a right and left direction of the back bezel.

18. The electronic apparatus of claim 14, wherein a metallic plate is attached at a position at which the light-emitting element of the back bezel is provided.

19. The electronic apparatus of claim 14, wherein a heat sink is attached at a position at which the light-emitting element of the back bezel is provided.

20. The electronic apparatus of claim 14, wherein a heat pipe in which a heat radiation portion is arranged outside the first and second through-holes is attached at a position at which the light-emitting element of the back bezel is provided.
